(19) United States
(12) Patent Application Publication
(10) Pub. No.: US 2006/0104605 A1
(43) Pub. Date: May 18, 2006

(54) Method and apparatus for recording image data

(75) Inventors: Sang-joon Park, Suwon-si (KR); Du-il Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/274,168

(22) Filed: Nov. 16, 2005

(30) Foreign Application Priority Data
Nov. 17, 2004 (JP) 10-2004-0094269

(51) Int. Cl. H04N 5/76

(52) U.S. Cl. 386/46

(57) ABSTRACT

A method and apparatus for recording image data, which minimizes data losses due to exceptional situations. The method includes storing image data in at least one fragmented file, each file having a predetermined size and creating one image data by gathering the fragmented files. Before creating the one image data, meta information on the at least one fragmented file may be updated, and the one image data may be created by gathering the at least one fragmented file based on the updated meta information. Accordingly, even if recording abnormally ends due to an exceptional situation, image data can be restored using the metadata, and the image data can be stably recorded by minimizing data losses.

### CROSS-REFERENCE TO RELATED PATENT APPLICATION

This application claims the benefit of Korean Patent Application No. 10-2004-0094269, filed on Nov. 17, 2004, in the Korean Intellectual Property Office, the disclosure of which is incorporated herein in its entirety by reference.

### BACKGROUND OF THE INVENTION

1. Field of the Invention

The present invention relates to a video recording apparatus and method, and more particularly, to a method and apparatus for recording image data, which minimizes data losses due to exceptional situations.

2. Description of the Related Art

Recently, various video recording devices such as digital camcorders, digital cameras, and cellphones supporting moving pictures, which capture images and record the captured image data (or video stream data), are being spotlighted. A method of recording image data (or video stream data) in the video recording devices includes operations of opening a file when recording starts, storing image data in a storage medium, such as a memory stick, or a memory buffer, and closing the file when the recording ends.

FIG. 1 is a flowchart illustrating a conventional method of recording image data. Referring to FIG. 1, when a user pushes a recording button, a file is opened or created, images are captured, and the captured images are stored. If the recording ends by the user pushing a stop button, the file being stored is closed. The recording normally ends by a file close command, and the recorded file can be used in various ways.

FIG. 2 illustrates a memory architecture of the conventional method of recording image data. Referring to FIG. 2, if the recording starts, a beginning address of a memory in which the image data is stored in response to a file open command is read, and the image data is sequentially recorded from a location of the memory corresponding to the beginning address.

There is no problem if the recording normally ends by the user pushing the stop button. FIG. 3 illustrates a memory architecture of a case where the image data is normally recorded according to the conventional recording method. Referring to FIG. 3, if a recording stop request is received from the user on the process where the image data is being recorded from the memory location of the beginning address obtained in response to the file open command, the file being recorded is closed, and the recording normally ends. If a recording request is received from the user again, new image data is recorded in response to a file open command by reading a beginning address at a predetermined location in another available memory space except a region in which image data was normally recorded. Like this, if the recording normally ends by the recording stop request being received from the user, the file close command is normally performed, and the recorded image data also can be effectively used.

However, a problem is generated when recording abnormally ends due to occurrence of an unexpected situation. That is, exceptional situations such that a system is down or a problem occurs in a storage device due to several reasons can occur. FIG. 4 illustrates a memory architecture of a case where an exceptional situation occurs while image data is being recorded according to the conventional recording method. Referring to FIG. 4, if the exceptional situation occurs while image data is being recorded, the recording abnormally ends since the file close command cannot be performed. In this case, previously recorded all image data remains in the memory, but when new recording is tried, a memory portion in which the previously recorded image data is stored is neglected, and new data may be overwritten. Therefore, the previously recorded image data may not be preserved. That is, the conventional data recording method is unstable.

### SUMMARY OF THE INVENTION

The present invention provides a method and apparatus for stably recording image data by minimizing data losses due to exceptional situations.

According to an aspect of the present invention, there is provided a method of recording image data, which includes storing the image data in at least one fragmented file, each file having a predetermined size; and creating one image data by gathering the at least one fragmented file.

Before creating the one image data, the method may further comprise updating meta information on the at least one fragmented file, and in creating the one image data, one image data may be created by gathering the at least one fragmented file based on the updated meta information.

The meta information may include reference information and location information on the least one fragmented file in which the one image data is divided and stored.

The meta information may be implemented using a markup language according to a Music Photo Video (MPV) standard.

In the storing of the image data in at least one fragmented file, procedures of opening a fragmented file, storing captured images in the opened fragmented file and closing the opened fragmented file may be repeated until recording of predetermined image data ends.

After the opened fragmented file is closed, the method may further comprise updating meta information on relevant fragmented files.

According to another aspect of the present invention, there is provided a method of recording image data, the method comprising: opening a fragmented file and storing captured images in the fragmented file; updating meta information on the fragmented file; and closing the fragmented file, wherein the operations are repeated until recording of predetermined image data ends.

According to another aspect of the present invention, there is provided a method of restoring image data, the method comprising: reading and analyzing meta information on at least one fragmented file stored by dividing the image data in a predetermined size; and gathering the at least one fragmented file into one image data based on the analyzed meta information.

According to another aspect of the present invention, there is provided a computer readable recording medium having recorded thereon a computer readable program for performing the image data recording method described above.

According to another aspect of the present invention, there is provided an image recording apparatus comprising: a storage unit storing image data in at least one fragmented file, each file having a predetermined size; a management unit managing meta information on the at least one fragmented file; and a creation unit creating one image data by gathering the at least one fragmented file based on the meta information.

The image recording apparatus may be one of a digital camcorder, a digital camera, a cellphone supporting moving pictures and a personal digital assistant (PDA) supporting moving pictures.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a conventional method of recording image data;

FIG. 2 illustrates a memory architecture of the conventional method of recording image data;

FIG. 3 illustrates a memory architecture of a case where image data is normally recorded according to the conventional recording method;

FIG. 4 illustrates a memory architecture of a case where an exceptional situation occurs while image data is being recorded according to the conventional recording method;

FIG. 5 is a flowchart illustrating a method of recording image data according to an exemplary embodiment of the present invention;

FIG. 6 is a flowchart illustrating a data restoring method of a case where an exceptional situation occurs while image data is being recorded;

FIG. 7 is illustrates a memory architecture of a case where image data is recorded according to an exemplary embodiment of the present invention; and

FIG. 8 is an example of metadata used in a process of recording image data according to an exemplary embodiment of the present invention.

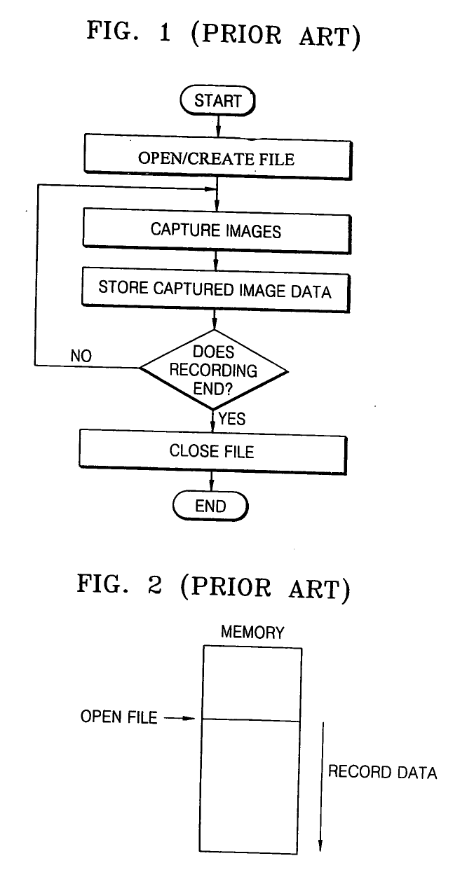

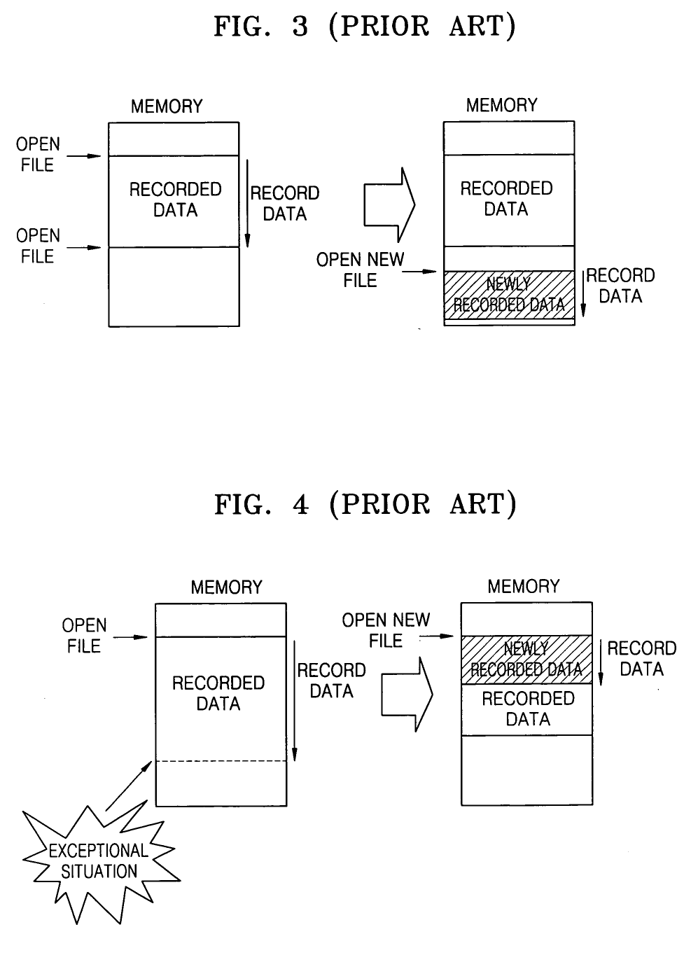

### DETAILED DESCRIPTION OF ILLUSTRATIVE, NON-LIMITING EMBODIMENTS OF THE INVENTION

Hereinafter, exemplary embodiments of the present invention will now be described in detail with reference to the accompanying drawings. The described exemplary embodiments are intended to assist in understanding the invention, and are not intended to limit the scope of the invention in any way.

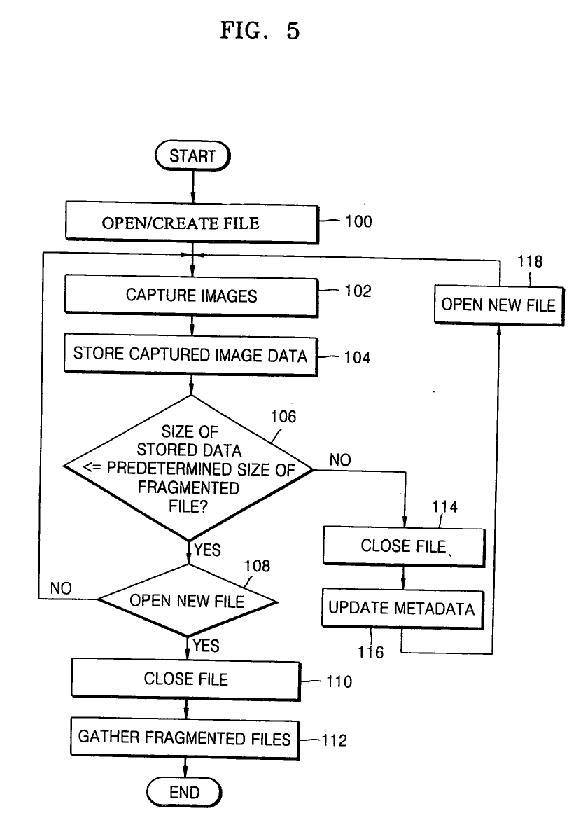

FIG. 5 is a flowchart illustrating a method of recording image data according to an exemplary embodiment of the present invention.

Referring to FIG. 5, unlike a conventional method, there is illustrated the method of recording image data, in which the image data is divided into fragmented files having a predetermined size and stored without continuously storing the image data after a file open command is performed. That is, there is illustrated the method of recording one image data in fragmented file units, each file having a predetermined size, by repeating procedures of opening a file for the first time, storing the file having the predetermined size, closing the file, opening a new file and storing the new file having the predetermined size. In addition, by updating metadata presenting features of the respective fragmented files, the metadata is used for creating one file by gathering the respective fragmented files in the future. The size of the fragmented file, which is a storing unit, can be adjusted in a proper size considering the performance of a recording apparatus or a characteristic of an application.

In due course, even if an exceptional situation occurs during recording of the image data, when a system is restored, one file can be created by gathering the previously stored fragmented files based on the metadata. Accordingly, the image data recorded before the occurrence of the exceptional situation can be recovered.

In more detail, in order to record image data according to the present exemplary embodiment, a beginning address of a memory from which the image data is recorded is obtained by performing a file open command or a file create command in operation 100. Images are captured in operation 102, and image data of the captured images is stored in fragmented file units, each fragmented file having a predetermined size, in operation 104. If the size of the stored image data is less than the predetermined size of the fragmented file in operation 106, the recording of image data is continued, and if the size of the stored image data is greater than the predetermined size of the fragmented file in operation 106, a file close command is performed in operation 114. Then metadata of the recorded fragmented file is updated in operation 116. The updating of metadata will be described later. Since the recording of one fragmented file ends, a new file open command is performed in operation 118, and the procedures of recording image data in fragmented file units are repeated. If the recording of the image data is all finished, or if a recording stop request is received from a user in operation 108, the recording fragmented file is closed in operation 110, and one image data file is created by gathering the fragmented files based on the updated metadata in operation 112. According to the procedures described above, the recording of the image data normally ends.

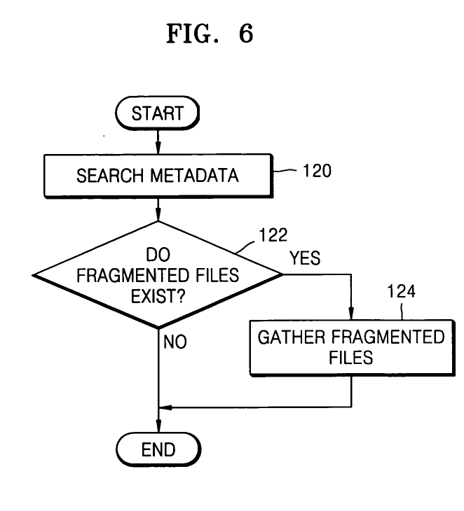

FIG. 6 is a flowchart illustrating a data restoring method of a case where an exceptional situation occurs while image data is being recorded. Referring to FIG. 6, a method of creating one image data file by gathering previously stored fragmented files using metadata even if an unexpected situation occurs while image data is being recorded. That is, if a recording apparatus such as a camcorder or a digital camera is turned off and on in an exceptional situation, the recording apparatus automatically searches metadata in operation 120 and seeks fragmented files based on the searched metadata. If the fragmented files exist in operation 122, one image data file is created by gathering the fragmented files in operation 124. Accordingly, the image data temporarily stored in fragmented file units can be gathered and stored as one image data file. That is, even if an unexpected situation occurs while image data is being recorded, since one image data file is created by gathering previously stored fragmented files using metadata, data losses are minimized, and system stability increases.

According to a conventional image data recording method, if a recording operation unexpectedly stops due to the occurrence of an exceptional situation, such as a case where a recording apparatus is down or a storage medium such as a memory stick is removed in the middle of the recording of image data, and tries to restart the recording, previously recorded image data is neglected and new image data is recorded from an arbitrary location. That is, the previously recorded image data is overwritten and not available anymore. However, according to the present exemplary embodiment, by performing a file close command every time when storing image data in fragmented file units, each fragmented file having a predetermined size, even if the exceptional situation described above occurs, since file close commands have been performed for fragmented files before the occurrence of the exceptional situation, the previously stored fragmented files are available. Moreover, when the system is restored, one image data file is created by gathering the fragmented files based on metadata. Accordingly, the previously recorded image data can be restored.

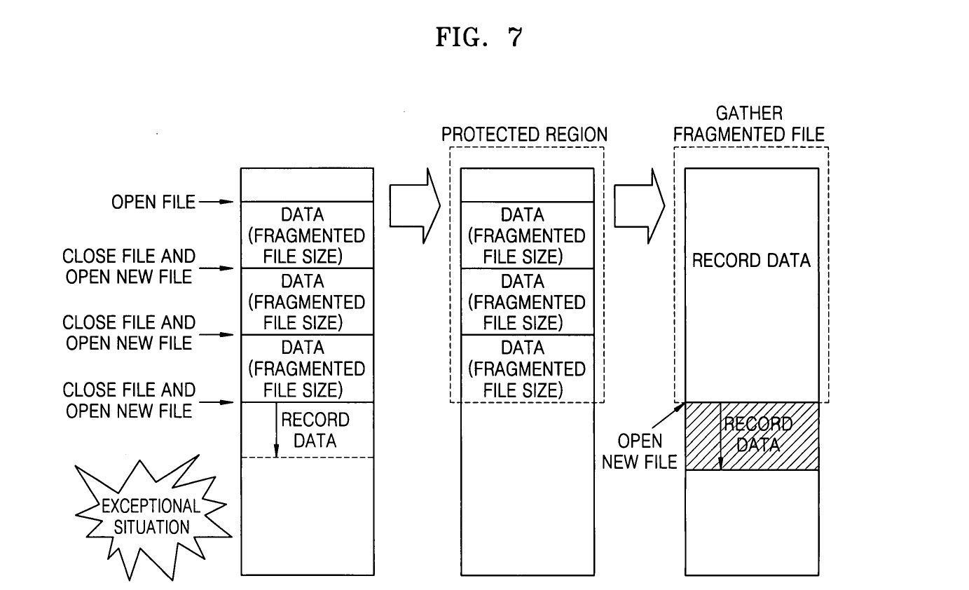

FIG. 7 illustrates a memory architecture of a case where image data is recorded according to an exemplary embodiment of the present invention.

Referring to FIG. 7, according to the image data recording and restoring methods according to the present exemplary embodiments, if recording starts, operations of opening a file, storing image data and closing the file are repeated in fragmented file units, each fragmented file having a predetermined size. Therefore, even if an exceptional situation occurs in the middle of the recording, all fragmented files of which file closing operations are performed before the occurrence of the exceptional situation are protected as shown in the center of FIG. 7. When a reproducing apparatus is turned on again, one file is automatically created by gathering the fragmented files based on metadata. Accordingly, data losses can be minimized and system stability can increase. As a result, all the previously fragmented files except a fragmented file being recorded at the occurrence timing of the exceptional situation can be recorded.

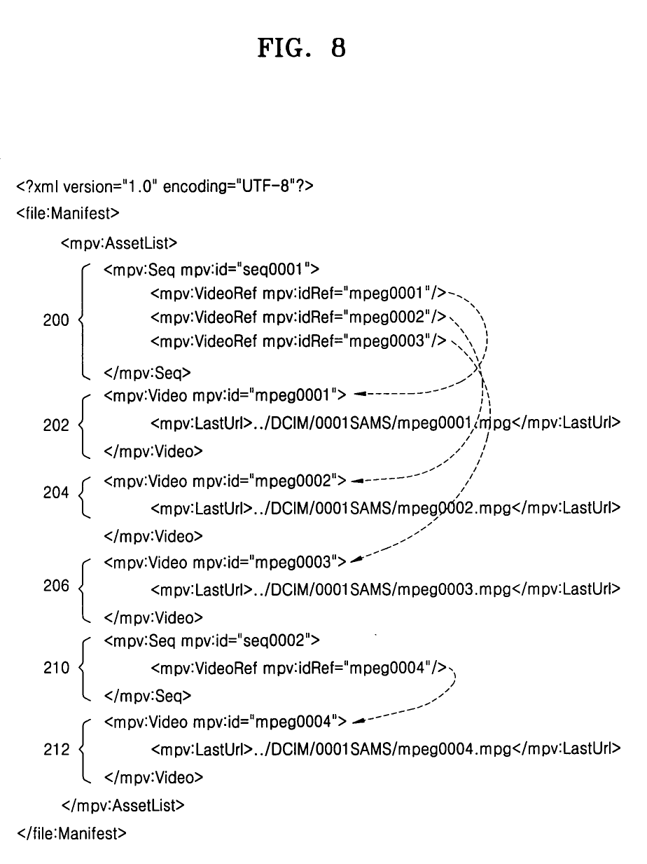

FIG. 8 is an example of metadata used in a process of recording image data according to an exemplary embodiment of the present invention.

Referring to FIG. 8, an example of metadata used in the updating of the metadata in operation 116 of FIG. 5 is illustrated. For example, it is assumed that the names of three already stored fragmented files shown in FIG. 7 are mpeg001.mpg, mpeg002.mpg and mpeg003.mpg and the name of a newly stored fragmented file is mpeg4.mpg. Since the mpeg001.mpg to mpeg003.mpg files are fragmented files stored as the user pushed a recording button, it is necessary that they are defined as one image data. Thus, when the recording ends, one image data file is created by gathering the mpeg001.mpg to mpeg003.mpg files using the metadata shown in FIG. 8. Since the mpeg4.mpg file is a fragmented file stored as the user pushed the recording button again after a predetermined time, the mpeg4.mpg file may be processed as a separate image data file.

FIG. 8 shows that the above example is implemented as metadata according to the MPV standard suggested by Optical Storage Technology Association (OSTA). Referring to FIG. 8, in the metadata according to the present exemplary embodiment, two image data 200 and 210 are defined. An mpv:Seq element indicates one image data file, i.e., a video clip file, which is a recording unit of image data.

In each image data file, at least one mpv:Video element corresponding to a subelement of the mpv:Seq element is defined, and each mpv:Video element may include URL locations of fragmented files included in one image data. An mpv:Seq element, which is one image data file, is formed by gathering a plurality of mpv:Video elements. The metadata may include reference information and location information of at least one fragmented file in which image data is divided and stored. Referring to FIG. 8, mpv:VideoRef elements correspond to the reference information of the fragmented files, and mpv:LastUrl elements correspond to location information of the fragmented files.

It is efficient in terms of management that an identifier of an mpv:Video element (e.g., mpv:id=“mpeg0001”) is equal to a file name of an actual fragmented file (../DCIM/0001SAMS/mpeg0001.mpg) since time for processing scripts of the metadata can be saved. That is, in this case, only an mpv:Seq element, which is an image data file, is created while image data is being recorded, and mpv:Video elements can be created based on recorded mpv:idRef elements when the recording ends or before new image data is recorded. If the recording apparatus is sufficiently fast, identifiers of mpv:Video elements can be defined differently from file names of actual fragmented files. When image data is recorded, the metadata shown in FIG. 8 is always updated in response to a current recording state.

Accordingly, when recording normally ends as shown in FIG. 5, or when recording abnormally ends due to an exceptional situation and image data is restored as shown in FIG. 6, information on fragmented files forming one image data is confirmed using metadata as shown in FIG. 8, and one image data file is created by gathering the fragmented files based on the confirmed information.

In the present exemplary embodiment, an example of metadata implemented according to the MPV standard is described. However, the implementation of metadata does not have to necessarily conform to the MPV standard and the metadata can be implemented using an XML, which is a general markup language, or another language.

The image data recording method using metadata according to exemplary embodiments of the present invention can be written as computer programs. The codes and code segments for embodying the computer programs may be easily deducted by programmers in the art which the present invention belongs to. And the programs can be stored in a computer-readable recording medium and implemented in general-use digital computers that execute the programs in order to implement the image data recording method using metadata. Examples of the computer-readable recording medium include magnetic storage media (e.g., ROM, floppy disks, hard disks, etc.), optical recording media (e.g., CD-ROMs, DVDs, etc.), and storage media such as carrier waves (e.g., transmission through the internet).

As described above, according to exemplary embodiments of the present invention, there is provided a method and apparatus for recording image data, which minimizes data losses due to exceptional situations.

That is, there is provided a method of storing images data in fragmented file units, each fragmented file having a predetermined size and creating one image data file by gathering the fragmented files, and to do this, metadata is defined. Accordingly, even if recording abnormally ends due to an exceptional situation, image data can be restored using the metadata, and the image data can be stably recorded by minimizing data losses.

While this invention has been particularly shown and described with reference to exemplary embodiments thereof, it will be understood by those skilled in the art that various changes in form and details may be made therein without departing from the spirit and scope of the invention as defined by the appended claims. The above-described exemplary embodiments should be considered in a descriptive sense only and are not for purposes of limitation. Therefore, the scope of the invention is defined not by the detailed description of the invention but by the appended claims, and all differences within the scope will be construed as being included in the present invention.

What is claimed is:

1. A method of recording image data, the method comprising:
storing the image data in at least one fragmented file, each fragmented file having a predetermined size; and
creating one image data by gathering the at least one fragmented file.

2. The method of claim 1, further comprising, before creating the one image data, updating meta information on the at least one fragmented file,
wherein the one image data is created by gathering the at least one fragmented file based on the updated meta information.

3. The method of claim 2, wherein the meta information includes reference information and location information on the at least one fragmented file in which the image data is divided and stored.

4. The method of claim 2, wherein the meta information is implemented using a markup language according to a Music Photo Video (MPV) standard.

5. The method of claim 1, wherein in the storing of the image data in at least one fragmented file, procedures of opening at least one of the fragmented files, storing captured images in the at least one opened fragmented file and closing the at least one opened fragmented file are repeated until recording of predetermined image data ends.

6. The method of claim 5, further comprising, after the fragmented file is closed, updating meta information on relevant fragmented files.

7. A method of recording image data, the method comprising:
opening one fragmented file and storing captured images in the fragmented file;
updating meta information on the fragmented file; and
closing the fragmented file,
wherein the operations are repeated until recording of predetermined image data ends.

8. A method of restoring image data, the method comprising:
reading and analyzing meta information on at least one fragmented file stored by dividing the image data in a predetermined size; and
gathering the at least one fragmented file into one image data based on the analyzed meta information.

9. A computer readable recording medium having recorded thereon a computer readable program for performing an image data recording method comprising:
storing image data in at least one fragmented file, each fragmented file having a predetermined size; and
creating one image data by gathering the at least one fragmented file.

10. A computer readable recording medium having recorded thereon a computer readable program for performing an image data recording method comprising:
opening a fragmented file and storing captured images in the fragmented file;
updating meta information on the fragmented file; and
closing the fragmented file,
wherein the operations are repeated until recording of predetermined image data ends.

11. A computer readable recording medium having recorded thereon a computer readable program for performing an image data restoring method comprising:
reading and analyzing meta information on at least one fragmented file stored by dividing the image data in a predetermined size; and
gathering the at least one fragmented file into one image data based on the analyzed meta information.

12. An image recording apparatus comprising:
a storage unit storing image data in at least one fragmented file, each fragmented file having a predetermined size;
a management unit managing meta information on the at least one fragmented file; and
a creation unit creating one image data by gathering the at least one fragmented file based on the meta information.

13. The apparatus of claim 12, wherein the image recording apparatus is one of a digital camcorder, a digital camera, a cellphone supporting moving pictures and a personal digital assistant (PDA) supporting moving pictures.
